(19) United States
(12) Patent Application Publication
(10) Pub. No.: US 2019/0030861 A1
(43) Pub. Date: Jan. 31, 2019

(54) COMPOSITE LAMINATE WITH HIGH DEPTH OF COMPRESSION

(71) Applicant: CORNING INCORPORATED, Corning, NY (US)

(72) Inventors: Robert Alan Bellman, Ithaca, NY (US); Michael Thomas Gallagher, Painted Post, NY (US); Vitor Marino Schneider, Painted Post, NY (US)

(21) Appl. No.: 16/045,302

(22) Filed: Jul. 25, 2018

Related U.S. Application Data
(60) Provisional application No. 62/537,603, filed on Jul. 27, 2017.

(51) Int. Cl. B32B 17/06; B32B 37/14; C03C 27/06

(52) U.S. Cl. CPC B32B 17/06; B32B 37/144; C03C 27/06; C03C 21/002; B32B 2457/20; B32B 2250/02; B32B 2250/03; B32B 2307/54

(57) ABSTRACT

Glass-based articles having a thickness (t) comprise a glass-based core substrate and at least one cladding substrate directly bonded to the glass-based core substrate. A stress profile may comprise a depth of compression (DOC) where the glass-based article has a stress value of zero, the DOC being located at 0.15·t, 0.18·t, 0.21·t, or deeper. The articles may be formed from one or more cladding substrates formed from cladding sheets having a thickness of at least 0.15·t, 0.18·t, 0.21·t, or more. Consumer electronic products may comprise the glass-based articles. Upon lamination, the articles may optionally be further exposed to heat and/or chemical treatments for further strengthening.

### CROSS-REFERENCE TO RELATED APPLICATIONS

This application claims the benefit of priority of U.S. Provisional Patent Application Ser. No. 62/537,603 filed on Jul. 27, 2017, the content of which is relied upon and incorporated herein by reference in its entirety.

### FIELD

Embodiments of the disclosure generally relate to glass-based articles that are composite laminates having engineered stress profiles with high depth of compression and methods for manufacturing the same.

### BACKGROUND

Strengthened glass-based articles are widely used in electronic devices as cover plates or windows for portable or mobile electronic communication and entertainment devices, such as mobile phones, smart phones, tablets, video players, information terminal (IT) devices, laptop computers, navigation systems and the like, as well as in other applications such as architecture (e.g., windows, shower panels, countertops etc.), transportation (e.g., automotive, trains, aircraft, sea craft, etc.), appliance, or any application that requires superior fracture resistance but thin and light-weight articles. Strengthening methods include but are not limited to lamination of sheets or substrates, thermal treatment (annealing), and/or chemical treatment. Suitable materials for inclusion in glass-based articles are amorphous and/or (poly)crystalline. (Poly)crystalline is used to refer collectively to both single crystalline materials and polycrystalline materials. Amorphous materials include but are not limited to glasses such as soda-lime silicate glass (SLS), alkali-alumino silicate glass, alkali-containing borosilicate glass, alkali-containing aluminoborosilicate glass, and alkali-free alumino silicate glass. (Poly)crystalline materials such as aluminum oxy-nitride (ALON), spinel, sapphire, zirconia, and glass-ceramic materials (GC) may be suitable.

Many strengthened glass-based articles have a compressive stress that is highest or at a peak at or near the surface and reduces from a peak value moving away from the surface, and there is zero stress at some interior location of the glass-based article before the stress in the glass-based article becomes tensile. A depth of compression (DOC) is where the glass-based article has a stress value of zero (i.e., where the stress switches from compressive stress to tensile stress). For glass-based articles having a single sheet or substrate, strengthening by annealing and/or chemical treatment is limited by a classic theoretical limit of 21% of thickness of the article for a DOC. Deep or high DOCs provide superior performance against damage.

There is an on-going need to provide glass-based articles having high depths of compression.

### SUMMARY

Aspects of the disclosure pertain to glass-based articles and methods for their manufacture.

In an aspect, an article comprises: a thickness (t); a glass-based core substrate; a cladding substrate directly bonded to the glass-based core substrate; and a stress profile comprising a depth of compression (DOC) that is located at 0.15·t or deeper.

Another aspect is an article comprising: a thickness (t); a glass-based core substrate having a core coefficient of thermal expansion (CTEₛ) and opposing first and second surfaces; a first cladding substrate having a first cladding coefficient of thermal expansion (CTE_{c1}) and opposing third and fourth surfaces, the third surface being directly bonded to the first surface to provide a first core-cladding interface; and a second cladding substrate having a second cladding coefficient of thermal expansion (CTE_{c2}) and opposing fifth and sixth surfaces, the fifth surface being directly bonded to the second surface to provide a second core-cladding interface; and wherein the first cladding substrate is formed from a sheet having a thickness of t_{c1} and the second cladding substrate is formed from a sheet having a thickness of t_{c2}, and at least one of t_{c1} and t_{c2} is at least 0.15·t.

Another aspect provides consumer electronic products comprising: a housing having a front surface, a back surface, and side surfaces; electrical components provided at least partially within the housing, the electrical components including at least a controller, a memory, and a display, the display being provided at or adjacent the front surface of the housing; and a cover substrate disposed over the display, wherein the cover substrate and/or the housing include any article disclosed herein.

In a further aspect, a method of manufacturing an article having a thickness (t) comprises: processing a core glass-based material to form a glass-based core substrate; processing a first cladding material that is glass, crystalline, or glass-ceramic to form a first cladding substrate; directly bonding the first cladding substrate to a first side of the glass-based core substrate without a polymer or adhesive; and wherein the first cladding material has a thickness of t_{c1}, and t_{c1} is at least 0.15·t.

According to aspect (1), an article is provided. The article comprises: a thickness (t); a glass-based core substrate; a cladding substrate directly bonded to the glass-based core substrate; and a stress profile comprising a depth of compression (DOC) that is located at 0.15·t or deeper.

According to aspect (2), the article of aspect (1) is provided, wherein the glass-based core substrate has opposing first and second surfaces and the cladding substrate has opposing third and fourth surfaces, the third surface being directly bonded to the first surface to provide a core-cladding interface, and a compressive stress region of the stress profile begins at the fourth surface and extends to the DOC.

According to aspect (3), the article of aspect (1) or (2) is provided, wherein the cladding substrate is formed from a sheet having a thickness of t_{c1}, which is at least 0.15·t.

According to aspect (4), the article of aspect (3) is provided, wherein t_{c1} is at least 0.21·t.

According to aspect (5), the article of aspect (4) is provided, wherein t_{c1} is at least 0.25·t.

According to aspect (6), the article of any of aspects (1) to (5) is provided, wherein the glass-based core substrate has a core coefficient of thermal expansion (CTEₛ) and the cladding substrate has a cladding coefficient of thermal expansion (CTE_{c}), wherein the CTEₛ is different from the CTE_{c}.

According to aspect (7), the article of aspect (6) is provided, wherein CTEₛ is greater than CTE_{c}.

According to aspect (8), the article of any of aspects (1) to (7) is provided, wherein the DOC is located at 0.21·t or deeper.

According to aspect (9), the article of aspect (8) is provided, wherein the DOC is located at 0.25·t or deeper.

According to aspect (10), the article of any of aspects (1) to (7) is provided, wherein the DOC is in a range of approximately 0.15·t to 0.49·t.

According to aspect (11), the article of aspect (10) is provided, wherein the DOC is in the range of approximately 0.21·t to 0.40·t.

According to aspect (12), the article of any of aspects (1) to (11) is provided, wherein the t is in a range of 0.1 mm to 10 mm.

According to aspect (13), the article of any of aspects (1) to (12) is provided, wherein the cladding substrate is bonded to the core substrate by fusion bonding, covalent bonding, or hydroxide-catalyzed bonding.

According to aspect (14), the article of any of aspects (1) to (13) is provided, wherein the glass-based core substrate comprises a first glass composition and the cladding substrate comprises a second glass composition, wherein the first glass composition is different from the second glass composition.

According to aspect (15), the article of any of aspects (1) to (14) is provided, wherein the stress profile comprises an absolute value of stress slope at the DOC in the range of from 0.01 MPa/micron to 40 MPa/micron.

According to aspect (16), the article of aspect (15) is provided, wherein the absolute value of the stress slope at the DOC is 10 MPa/microns or less.

According to aspect (17), the article of any of aspects (1) to (16) is provided, wherein the stress profile comprises an absolute value of maximum tensile stress of 2 MPa or more.

According to aspect (18), the article of aspect (17) is provided, wherein the absolute value of maximum tensile stress is 50 MPa or more.

According to aspect (19), the article of any of aspects (1) to (18) is provided, further comprising one or more additional cladding substrates bonded to a surface of the glass-based core substrate, the cladding substrate, or both.

According to aspect (20), the article of any of aspects (1) to (19) is provided, wherein the glass-based core substrate comprises a glass or a glass-ceramic.

According to aspect (21), the article of any of aspects (1) to (20) is provided, wherein the cladding substrate is a crystalline material or a glass-ceramic.

According to aspect (22), the article of any of aspects (1) to (21) is provided, wherein the cladding substrate is strengthenable.

According to aspect (23), the article of any of aspects (1) to (22) is provided, wherein the cladding substrate comprises a crystalline material selected from the group consisting of: aluminum oxy-nitride (ALON), spinel, sapphire, zirconia, and combinations thereof.

According to aspect (24), the article of any of aspects (1) to (23) is provided, wherein at least one of the cladding substrate and the glass-based core substrate is substantially free of lithium.

According to aspect (25), a consumer electronic product is provided. The consumer electronic product comprises: a housing having a front surface, a back surface, and side surfaces; electrical components provided at least partially within the housing, the electrical components including at least a controller, a memory, and a display, the display being provided at or adjacent the front surface of the housing; and a cover substrate disposed over the display. At least a portion of at least one of the cover substrate and the housing comprises the article of any one of aspects (1) to (24).

According to aspect (26), an article is provided. The article comprises: a thickness (t); a glass-based core substrate having a core coefficient of thermal expansion (CTEₛ) and opposing first and second surfaces; a first cladding substrate having a first cladding coefficient of thermal expansion (CTE_{c1}) and opposing third and fourth surfaces, the third surface being directly bonded to the first surface to provide a first core-cladding interface; and a second cladding substrate having a second cladding coefficient of thermal expansion (CTE_{c2}) and opposing fifth and sixth surfaces, the fifth surface being directly bonded to the second surface to provide a second core-cladding interface. The first cladding substrate is formed from a sheet having a thickness of t_{c1} and the second cladding substrate is formed from a sheet having a thickness of t_{c2}, and at least one of t_{c1} and t_{c2} is at least 0.15·t.

According to aspect (27), the article of aspect (26) is provided, wherein CTEₛ is greater or equal to than each of CTE_{c1} and CTE_{c2}.

According to aspect (28), the article of aspect (26) is provided, wherein CTE_{c1} and CTE_{c2} are each greater than CTEₛ.

According to aspect (29), the article of aspect (26) is provided, comprising a stress profile having a compressive stress region extending from the fourth surface to a depth of compression (DOC), the DOC being located at 0.15·t or deeper, and a tensile stress region extending from the DOC to a maximum tensile stress.

According to aspect (30), the article of aspect (29) is provided, wherein the DOC is located at 0.21·t or deeper.

According to aspect (31), the article of aspect (30) is provided, wherein the DOC is located at 0.25·t or deeper.

According to aspect (32), the article of aspect (29) is provided, wherein the DOC is in a range of approximately 0.15·t to 0.49·t.

According to aspect (33), the article of aspect (32) is provided, wherein the DOC is in the range of approximately 0.21·t to 0.40·t.

According to aspect (34), the article of any of aspects (26) to (33) is provided, wherein the glass-based article has a thickness in a range of 0.1 mm to 10 mm.

According to aspect (35), the article of any of aspects (26) to (34) is provided, wherein the first cladding substrate and the second cladding substrate are each bonded to the glass-based core substrate by fusion bonding, covalent bonding, or hydroxide-catalyzed bonding.

According to aspect (36), the article of any of aspects (26) to (35) is provided, wherein the glass-based core substrate comprises a first glass composition and the first cladding substrate and second cladding substrate each comprises a second glass composition, wherein the first glass composition is different from the second glass composition.

According to aspect (37), the article of any of aspects (29) to (36) is provided, wherein the stress profile comprises an absolute value of stress slope at the DOC in the range of from 0.01 MPa/micron to 40 MPa/micron.

According to aspect (38), the article of aspect (37) is provided, wherein the absolute value of stress slope at the DOC is 10 MPa/microns or less.

According to aspect (39), the article of any of aspects (29) to (38) is provided, wherein the stress profile comprises an absolute value of maximum tensile stress of 2 MPa or more.

According to aspect (40), the article of aspect (39) is provided, wherein the absolute value of tensile stress is 50 MPa or more.

According to aspect (41), the article of any of aspects (26) to (40) is provided, wherein at least one of the first cladding substrate, the second cladding substrate, and the glass-based core substrate is substantially free of lithium.

According to aspect (42), a consumer electronic product is provided. The consumer electronic product comprises: a housing having a front surface, a back surface, and side surfaces; electrical components provided at least partially within the housing, the electrical components including at least a controller, a memory, and a display, the display being provided at or adjacent the front surface of the housing; and a cover substrate disposed over the display. At least a portion of at least one of the cover substrate and the housing comprises the article of any one of aspects (26) to (41).

According to aspect (43), a method of manufacturing an article having a thickness (t) is provided. The method comprises: directly bonding a first cladding substrate that is glass, crystalline, or glass-ceramic to a first side of a glass-based core substrate. The first cladding material has a thickness of t_{c1}, and t_{c1} is at least 0.15·t, the article has a stress profile having a compressive stress (CS) at or below a surface of the article and a compressive region extending to a depth of compression (DOC), the DOC being located at 0.15·t or deeper, and a tensile stress region extending from the DOC to a maximum tensile stress

According to aspect (44), the method of aspect (43) is provided, further comprising bonding a second cladding substrate to a second side of the glass-based core substrate.

According to aspect (45), the method of aspect (43) is provided, further comprising cleaning the glass-based core substrate and the first cladding substrate; and placing a bonding surface of the glass-based core substrate in contact with a bonding surface of the first cladding substrate to provide a laminate stack.

According to aspect (46), the method of aspect (44) is provided, further comprising cleaning the glass-based core substrate, the first cladding substrate, and the second cladding surface; and placing a first bonding surface of the glass-based core substrate in contact with a bonding surface of the first cladding substrate and a second bonding surface of the glass-based core substrate in contact with a bonding surface of the second cladding substrate to provide a laminate stack.

According to aspect (47), the method of aspect (45) or (46) is provided, further comprising heating and/or treating the laminate stack to bond the bonding surfaces.

According to aspect (48), the method of aspect (47) is provided, wherein the first cladding substrate, the second cladding substrate, or both are bonded to the core substrate by fusion, covalent bonding, or hydroxide-catalyzed bonding.

According to aspect (49), the method of aspect (47) is provided, further comprising annealing the laminate stack at a temperature in a range from about 100° C. to about 1000° C. for a period of time of at least 30 minutes and up to 24 hours.

According to aspect (50), the method of aspect (43) is provided, further comprising chemically strengthening the first cladding substrate by ion exchange.

### BRIEF DESCRIPTION OF THE DRAWINGS

The accompanying figures, which are incorporated in and constitute a part of this specification, illustrate several embodiments described below.

FIG. 1 illustrates a schematic cross-section of a glass-based article according to an embodiment having at least two layers;

FIG. 2 illustrates a schematic cross-section of a glass-based article according to an embodiment having at least three layers;

FIG. 3A is a plan view of an exemplary electronic device incorporating any of the glass-based articles disclosed herein;

FIG. 3B is a perspective view of the exemplary electronic device of FIG. 3A;

FIG. 4 provides a graph of a modelled stress profile of two exemplary glass-based articles (high DOC) as compared to theoretical stress profiles for comparative single-layered articles;

FIG. 5 provides an optical micrograph of a three-layered glass-based article according to Example 1;

FIG. 6 provides a graph of a measured stress profile of the three-layered glass-based article according to Example 1;

FIG. 7 provides a graph of a measured stress profile of a three-layered glass-based article according to Example 2;

FIG. 8 provides a graph of a measured stress profile of a half width of a three-layered glass-based article according to Example 3;

FIG. 9 provides a graph of a measured stress profile of a half width of a three-layered glass-based article according to Example 4;

FIG. 10 provides a graph of a center tension versus bonding temperature of a three-layered glass-based article according to Example 5; and

FIG. 11 provides a graph of stress as a function of normalized distance from a surface of a three-layered glass-based article according to Example 6; and

FIG. 12 provides a graph of stress as a function of distance from a surface of a three-layered glass-based article according to Example 7.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

The articles described herein include a glass-based core substrate laminated with one or more cladding substrates. The articles have an engineered or designed stress profile comprising a depth of compression (DOC) that may be about 15% of the article's thickness or deeper. For example, the DOC may be at least about 15%, 16%, 17%, 18%, 19%, 20%, 21%, 25%, 30%, 35%, 40%, 45%, or even 49% of the article's thickness, and all values and sub-ranges therebetween. In some embodiments, the DOC may be in the range of 0.15 to 0.49 of the article's thickness, such as 0.21 to 0.40 times the article's thickness. The articles may also have a stress profile having a high compressive stress (CS) spike at one or both of its surfaces. In one or more embodiments, the glass-based articles include designed stress profiles that provide resistance to failure due to damage. The glass-based articles may be used in automotive, aviation, architectural, appliance, display, touch panel, and other applications where a thin, strong, scratch resistant glass product is advantageous.

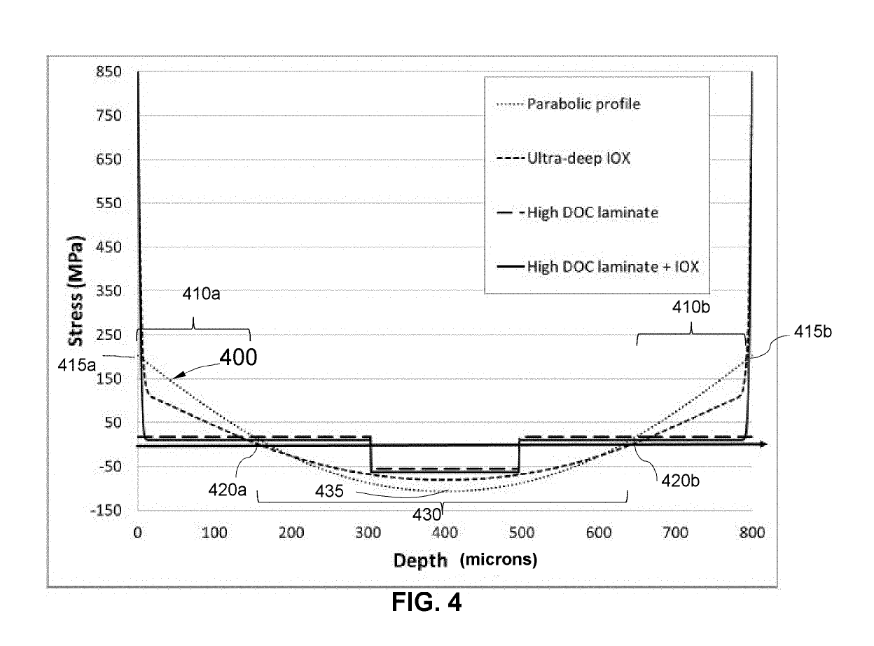

Achieving a high depth of compression (DOC) in a single glass-based sheet or substrate faces theoretical and manufacturing limits. The generally accepted upper theoretical limit of DOC is 21% of the thickness of the single sheet article, which is discussed further with respect to FIG. 4. In practice, achieving a DOC of 15-18% of the thickness of the single sheet article may not be practical or cost-effective depending on the sheet thickness and/or composition. Overcoming these physical and manufacturing limitations may open several new possibilities leading to glass articles that have very high performance, for example against damage introduction.

The glass-based articles herein provide high DOCs by laminating to a glass-based core substrate at least one cladding substrate formed from a sheet that is at least about 15% of the article's thickness. For example, the sheet that forms the cladding substrate may be at least about 15%, 16%, 17%, 18%, 19%, 20%, 21%, 25%, 30%, 35%, 40%, 45%, or even 49% of the article's thickness, and all values and sub-ranges therebetween.

As used herein, depth of compression (DOC) refers to the depth at which the stress within the glass-based article changes from compressive to tensile stress. At the DOC, the stress transitions from a positive (compressive) stress to a negative (tensile) stress and thus exhibits a stress value of zero.

The term “glass-based” includes any object made wholly or partly of glass, such as glass or glass-ceramic materials. Glass-based core substrates according to one or more embodiments can be selected from soda-lime silicate glass (SLS), alkali-alumino silicate glass, alkali-containing borosilicate glass, alkali-containing aluminoborosilicate glass, and alkali-free alumino silicate glass. In one or more embodiments, the core substrate is a glass, and the glass is strengthenable, for example, by lamination, heat treatment (annealing), and/or chemical treatment (e.g., ion exchange). In one or more embodiments, the glass-based core substrate is a glass-ceramic material. In one or more embodiments, the glass-based core substrate may be free or substantially free of lithium.

The term “cladding substrate” includes any object that is suitable to be laminated to a glass-based core substrate, which contributes to the overall functionality and/or use of the glass-based article. The cladding substrate may include glass materials, non-glass materials, and/or (poly)crystalline materials. In one or more embodiments, the cladding substrate is a glass, and the glass is strengthenable, for example, by lamination, heat treatment (annealing), and/or chemical treatment. In a detailed embodiment, the glass is ion exchangeable. In one or more embodiments, the cladding substrate is a single crystalline material, such as sapphire. In one or more embodiments, the cladding substrate is a polycrystalline material, such as aluminum oxy-nitride (ALON), spinel, sapphire, zirconia, and/or glass-ceramic materials (GC). In one or more embodiments, the cladding substrate may be free or substantially free of lithium.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass-based article that is “substantially free of MgO” is one in which MgO is not actively added or batched into the glass-based article, but may be present in very small amounts as a contaminant, such as less than about 0.1 mol. %.

Unless otherwise specified, all compositions described herein are expressed in terms of mole percent (mol. %) on an oxide basis. It should be understood that when a value herein is disclosed with the modifier “about” that the exact value is also disclosed. For example, “about 9” is intended to also disclose the exact value “9.”

According to the convention normally used in mechanical arts, compression is expressed as a negative (<0) stress and tension is expressed as a positive (>0) stress. Throughout this description, however, compressive stress (CS) is expressed as a positive or absolute value—i.e., as recited herein, CS=|CS|. In addition, tensile stress is expressed herein as a negative (<0) stress or absolute value—i.e., as recited herein, TS=|TS|. Central tension (CT) refers to tensile stress in the center of the glass-based article.

Unless otherwise specified, CT and CS are expressed herein in megaPascals (MPa), whereas thickness and DOC are expressed in millimeters or microns (micrometers). CS and DOC are measured using those means known in the art, such as by scattering polarimetry using a SCALP-5 measurement system from Glasstress (Estonia). It is noted that the SCALP-5 measurement system is not capable of determining the stresses at the edges of the part, for example the edge regions extending to depths of 200 microns from a surface of the glass-based article. This is due to the presence of excessive scattered light at the interface where the laser used in the metrology enters and exits the sample. However, in the interior of the sample the SCALP-5 measurement is able to accurately quantify the stress in the sample. Other possible techniques for measuring CS and DOC include a surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. DOC herein is measured by the SCALP-5 measurement system unless otherwise indicated. The stress in near surface regions may also be measured according to an inverse WKB (IWKB) method as described in U.S. Pat. No. 9,140,543, entitled “Systems and Methods for Measuring the Stress Profile of Ion-exchanged Glass,” the contents of which are incorporated herein by reference in their entirety.

According to one or more embodiments, deep DOCs can be achieved through a lamination process of a core substrate and at least one cladding substrate to form a laminate or a laminate stack. The different substrates may have differing coefficients of thermal expansion (CTEs). The lamination may happen in dual layers, triple layers, or 4 or more layers depending on the application. The laminate stack may be symmetrical or asymmetrical depending on the application. The laminate stack may then be further exposed to optional treatments such as heat and/or chemical treatment.

Stress is induced in a laminate during initial formation/bonding of the substrates due to the difference in CTE of the materials at the interface, which is discussed for example in U.S. Pat. No. 3,737,294 entitled “Method for making multi-layer laminated bodies” granted to Corning Glass Works on Jun. 5, 1973; U.S. Pat. No. 7,201,965 entitled “Glass laminate substrate having enhanced impact and static loading resistance” granted to Corning Incorporated on Apr. 10, 2007; and U.S. Pat. No. 9,522,836 entitled “Laminated and ion-exchanged strengthened glass laminates” granted to Corning Incorporated on Dec. 20, 2016, which are incorporated herein by reference in their entireties. For embodiments having a compressive stress at the article surface, the cladding substrate may have a CTE that is at least 10×10⁻⁷/° C. lower than the CTE of the core substrate, a CTE that is lower than the CTE of the core substrate by an amount in a range from about 10×10⁻⁷/° C. to about 70×10⁻⁷° C., a CTE that is lower than the CTE of the core substrate by an amount in a range from about 10×10⁻⁷1° C. to about 60×10⁻⁷1° C., or a CTE that is lower than the CTE of the core substrate by an amount in a range from about 10×10⁻⁷/° C. to about 50×10⁻⁷/° C.

Suitable bonding methods include but are not limited to: fusion bonding, covalent bonding, or hydroxide-catalyzed bonding. These bonding methods are understood to result in “directly” bonding the substrates. As used herein, “directly bonded” refers to a bond in which there is no additional bonding or polymeric material such as an adhesive, epoxy, glue, etc.

Fusion bonding may be achieved according to the process described in U.S. Pat. No. 9,522,836 or in a temperature-controlled oven. With fusion bonding, the sheets are put into contact in a fusion draw or flat surface at temperature above the softening point of the materials. The glass-based materials effectively fuse after controlled cooling to form a uniform laminate with induced stress based on the different mechanical properties of the sheets. For fusion bonding, a laminate fusion draw apparatus may be used to form a laminated glass article, where the apparatus includes an upper isopipe which is positioned over a lower isopipe. The upper isopipe includes a trough into which a molten cladding material composition is fed from a melter. Similarly, the lower isopipe includes a trough into which a molten glass-based core composition is fed from a melter. Temperatures of the glass-based core composition may range from 700° C. to 1000° C.

Hydroxide-catalyzed bonding involves a catalyst solution in the bonding together of sheets of glass and/or crystalline materials. In contrast to van der Waals bonding, hydroxide-catalyzed bonding does not require a quasi-atomically flat surface in order to work. With hydroxide-catalyzed bonding, a non-uniform polished sample and even curved samples may be bonded efficiently. For effective hydroxide-catalyzed bonding, surfaces are cleaned followed by the addition of a liquid or slurry catalyst between the materials to be bonded. An exemplary catalyst is sodium hydroxide or potassium hydroxide at a desired concentration. This can be done with and without hydrated silica that can be in the form of ground glass particles or sodium silicate. Low temperature thermal curing forms a strong bond by base catalyzed condensation of surface silanol groups of the substrates and the silicate solution, and removes excess water. Typically, this curing process is carried out at temperatures of less than 200° C. for a duration of minutes to days. Hydroxide-catalyzed bonding may change the index of refraction in the bonding interface compared to the substrates, which could result in some additional level of undesirable reflectance beyond the typical substrate index mismatch.

Covalent (van der Waals) bonding results from exposure to high temperatures, e.g., 350-450° C., where a bond is formed, the bond being a molecular/chemical bond, which involves sharing of electron pairs that are known as shared pairs or bonding pairs. According to one or more embodiments, covalent bonding may include σ-bonding, π-bonding, metal-to-metal bonding, agostic interactions, bent bonds, and three-center two-electron bonds. In an embodiment, the covalent bond comprises a Si—O—Si bond. Two flat clean glass surfaces spontaneously bond by van der Waals forces when brought into intimate contact. Van der Waals forces are very short range, so surfaces to be bonded are to be both flat and clean. Spontaneous bonding is not generally observed if surface roughness exceeds 1.6 nm. Similarly, surface organic and particulate contamination can screen the van der Waals forces and prevent bonding. In this bonding process, the glass surfaces are cleaned to remove all metal, organic and particulate residues, and to leave a mostly silanol terminated surface. The glass surfaces are first brought into intimate contact where van der Waals forces pull them together. With heat and optionally pressure, the surface silanol groups condense to form strong Si—O—Si bonds across the interface, permanently fusing the glass pieces. This fusing occurs typically in the range of 350-450° C. A high silanol surface concentration forms a strong bond as the number of bonds per unit area will be determined by the probability of two silanol species on opposing surfaces reacting to condense out water. The average number of hydroxyls per nm² for well hydrated silica has been reported as 4.6 to 4.9. (L. T. Zhuravlev, Colloids and Surfaces, A: Physicochemical and Engineering Aspects 173 (2000) 1).

In one or more embodiments, a process to bond the core substrate to one or more cladding substrates can include cleaning the surfaces of the core substrate and cladding substrate(s) with a high pH solution. For example, what is known as a RCA clean or Standard Clean 1 (SC1) process may be used. In one or more embodiments, a RCA clean process includes removal of organic contaminants (organic clean+particle clean), and removal of ionic contamination (ionic clean). The substrates can be soaked in water, such as deionized water, and rinsed with water between each step. In one or more embodiments, the cleaning can include only a SC1 process, which involves cleaning the substrates with a solution of deionized water and aqueous ammonium hydroxide (for example, 29% by weight NH₃) and hydrogen peroxide (for example, 30%). An exemplary SC1 solution can include 40 parts (by volume) water, 1 part ammonium hydroxide (NH₄OH) and 2 parts aqueous hydrogen peroxide (H₂O₂). The cleaning can occur at room temperature (for example, about 25° C.), or an elevated temperature in a range of 50° C. to 65° C. The substrates can be placed in the solution for 1 minute to 30 minutes. This solution cleaning removes organic residues and particles.

In addition to the compressive and tensile stresses produced by the CTE mismatch of the lamination, there is also a stress component imparted by diffusion that occurs at the interface between the substrates. This diffusion-attributed stress component is concentrated at the interface. The difference between the CTE mismatch, however, produces a stress profile across the whole thickness of the sample. Upon specifying the CTE mismatch, temperatures of the process, mechanical elastic constants of the substrates, and thicknesses of the substrates, the desired regions of compressive and tensile stress across the laminates can be designed, with the addition of the smaller diffusion component at the interfaces of the glass. It should be noted that temperature of typical laminate bonding processes is less than about 200° C. for the hydroxide catalyzed process, 350-450° C. for a van der Waals (covalent) bonding process, and above the softening point of the substrate for a fusion process.

Optionally, in addition to lamination, glass-based articles may be strengthened by thermal treatment (annealing) and thereby may achieve a deeper DOC. Stress formed during the initial lamination is superimposed with additional stresses produced by the thermal annealing and cooling. Thus, a thermal process of heating the article at high temperatures and cooling in a controlled environment can lead to further enhancement of the stress induced by the CTE mismatch. There also may be additional diffusion in the interface of the substrates during the thermal treatment. The optional annealing may provide further tuning of the stresses in the clad and core substrates beyond the initial lamination.

Optionally, in addition to lamination, glass-based articles may be strengthened by single-, dual-, or multi-step ion exchange (IOX) and thereby may achieve a deeper DOC and/or a higher peak compressive stress (CS). Stress formed during the initial lamination is superimposed with additional stresses produced by ion exchange. Additional stresses achieved in the surface by IOX facilitate inhibition of crack propagation, particularly at edges of the article. There also may be additional diffusion in the interface of the substrates during the IOX process. The optional ion exchange may provide further tuning of the stresses in the clad and core substrates beyond the initial lamination.

Non-limiting examples of ion exchange processes in which glass is immersed in multiple ion exchange baths, with washing and/or annealing steps between immersions, are described in U.S. Pat. No. 8,561,429, by Douglas C. Allan et al., issued on Oct. 22, 2013, entitled “Glass with Compressive Surface for Consumer Applications,” and claiming priority from U.S. Provisional Patent Application No. 61/079,995, filed Jul. 11, 2008, in which glass is strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass is strengthened by ion exchange in a first bath is diluted with an effluent ion, followed by immersion in a second bath having a smaller concentration of the effluent ion than the first bath. The contents of U.S. Pat. Nos. 8,561,429 and 8,312,739 are incorporated herein by reference in their entireties.

Optionally, in addition to lamination, glass-based articles may be strengthened by both thermal treatment (annealing) and single- or multi-step ion exchange and thereby may achieve deeper DOC and/or a higher peak compressive stress (CS). After lamination, the article may be annealed followed by ion exchange, or it may be ion exchanged followed by annealing.

The optional additional thermal and/or chemical treatments may provide further tuning of stresses in the cladding and core substrates beyond the initial lamination. Single-, dual-, or multi-step ion exchange processes may be desirable to produce a very high stress at the surface of the glass and very complex stress profiles. Ion exchange is suitable when glasses having free ions for ion-exchange are used in the cladding and/or core substrates. For example, alkali-alumino silicate glasses are suitable for ion exchange. In embodiments, the glasses may be free or substantially free of lithium. Moreover, alkali-free glasses such as display glasses, including “green” glasses that are fined with tin oxide and iron oxide and without the use of arsenic or antimony, are not ion exchangeable and are not used if ion exchange is envisioned.

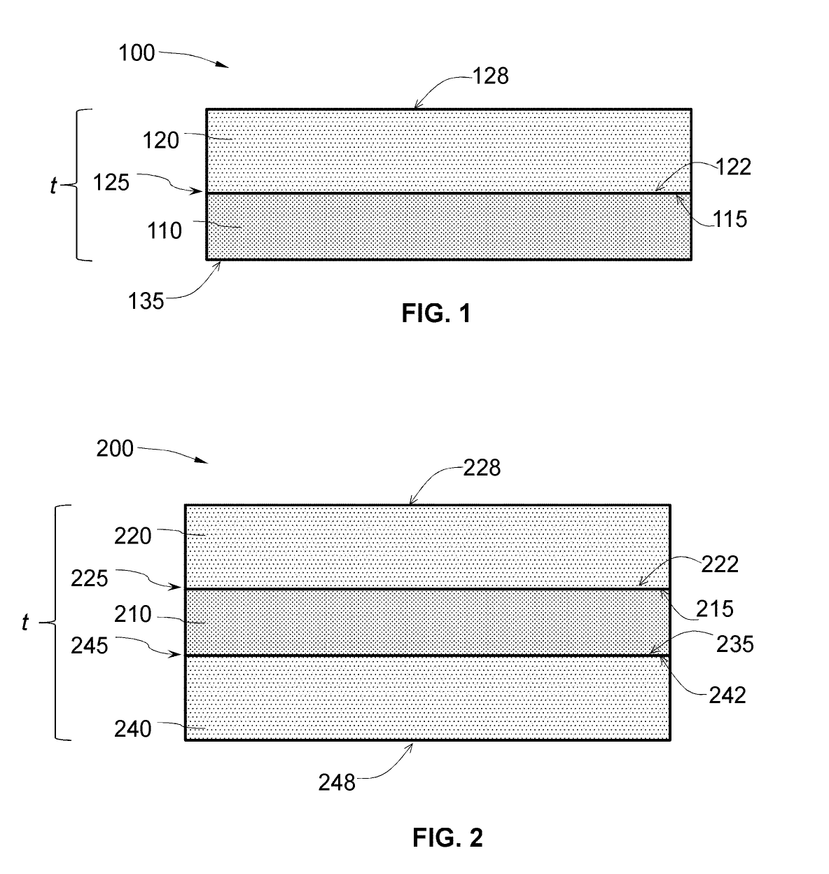

Turning to the figures, FIG. 1 illustrates a schematic cross-section of a glass-based article 100 having a thickness (t) and at least two layers, the article comprising a glass-based core substrate 110 and a cladding substrate 120. The glass-based core substrate 110 has a first surface 115 and a second surface 135. The cladding substrate 120 has a third surface 122 directly bonded to the first surface 115 to provide a core-cladding interface 125 and a fourth surface 128. According to one or more embodiments, the core substrate 110 is bonded to the cladding substrate 120 without a polymer or adhesive between the core substrate 110 and the cladding substrate 120. According to one or more embodiments, the substrates are directly bonded to each other.

The glass-based article 100 is shown having a thickness (t), which is the thickness of the final article upon lamination of the substrates and any optional thermal and/or chemical treatment. The core substrate 110 is formed from a core sheet having a thickness tₛ and the cladding substrate 120 is formed from a cladding sheet having a thickness t_{c}. The nominal thickness of the glass-based article 100 is the sum of t_{c} and tₛ, but it is understood that during bonding and optional heat and/or chemical treatment there may be diffusion of materials from either sheet into the other at the core-cladding interface, resulting in an actual article thickness that varies in some amount from the sum of t_{c} and tₛ. For the purposes of this disclosure, t_{c} and tₛ are measured based on the sheets used to form the substrates and t is measured based on the final laminated article. In one or more embodiments, the glass-based article of any embodiment disclosed herein has a thickness in a range of from 0.1 mm to 10 mm, 0.1 mm to 3 mm, or any sub-ranges contained therein. In an embodiment, the cladding substrate 120 is formed from a sheet having a thickness t_{c} that is at least 0.15·t, such as at least 0.18·t, 0.21·t, 0.25·t, 0.30·t, 0.35·t, 0.40·t, 0.45·t, or 0.49·t, and any values or sub-ranges therebetween. The sheet that forms the cladding substrate may be in a range of from 5 microns to 10,000 microns, 100 microns to 3,000 microns, or any sub-ranges contained therein. In an embodiment, the core substrate 110 is formed from a sheet having a thickness tₛ that may be in a range of from 5 microns to 10,000 microns, 100 microns to 3000 microns, or any sub-ranges contained therein.

The core substrate 110 may comprise a first glass composition and the cladding substrate 120 may comprise a second glass composition, wherein the first glass composition is different from the second glass composition. In an embodiment, the first glass composition has a first ion diffusivity and the second glass composition each has a second ion diffusivity, and the first ion diffusivity and second ion diffusivity are different. In an embodiment, the first glass composition has a first coefficient of thermal expansion (CTE) and the second glass composition has a second coefficient of thermal expansion (CTE), and the first CTE and second CTE are different. In an embodiment, the second CTE is lower than the first CTE to impart a compressive stress in the cladding substrate. In an embodiment, the second CTE is higher than the first CTE to impart a tensile stress in the cladding substrate. In an embodiment, the first and second CTEs are about the same.

In an embodiment, one or more additional cladding substrates are bonded to a surface of the core substrate, the cladding substrate, or both.

FIG. 2 illustrates a schematic cross-section of a glass-based article 200 having a thickness (t) and at least three layers, the article comprising a glass-based core substrate 210, a first cladding substrate 220, and a second cladding substrate 240. The glass-based core substrate 210 has a first surface 215 and a second surface 235. The first cladding substrate 220 has a third surface 222 directly bonded to the first surface 215 to provide a first core-cladding interface 225; the first cladding substrate 220 also has a fourth surface 228. The second cladding substrate 240 has a fifth surface 242 directly bonded to the second surface 235 to provide a second core-cladding interface 245; the second cladding substrate 240 also has a sixth surface 248. According to one or more embodiments, the core substrate 210 is bonded to the first cladding substrate 220 and the second cladding substrate 240 without a polymer or adhesive between the core substrate 210 and the first cladding substrate 220 or between the core substrate 210 and the second cladding substrate 240. According to one or more embodiments, the substrates are directly bonded to each other.

The glass-based article 200 is shown having a thickness (t), which is the thickness of the final article upon lamination of the substrates and any optional thermal and/or chemical treatment. The core substrate 210 is formed from a core sheet having a thickness tₛ, the first cladding substrate 220 is formed from a first cladding sheet having a thickness t_{c1}, and the second cladding substrate 240 is formed from a second cladding sheet having a thickness t_{c2}. The nominal thickness of the glass-based article 200 is the sum of t_{c1}, t_{c2}, and tₛ, but it is understood that during bonding and optional heat and/or chemical treatment there may be diffusion of materials from either sheet into the other at the core-cladding interface, resulting in an actual article thickness that varies in some amount from the sum of t_{c1}, t_{c2}, and tₛ. For the purposes of this disclosure, t_{c1}, t_{c2}, and tₛ are measured based on the sheet used to form the substrate and t is measured based on the final laminated article. In one or more embodiments, the glass-based article of any embodiment disclosed herein has a thickness in a range of from 0.1 mm to 10 mm, 0.1 mm to 3 mm, or any sub-ranges contained therein. In an embodiment, the first cladding substrate 220 is formed from a sheet having a thickness t_{c1} that is at least 0.15·t, such as at least 0.18·t, 0.21·t, 0.25·t, 0.30·t, 0.35·t, 0.40·t, 0.45·t, 0.49·t, or any values or sub-ranges therebetween. The sheet that forms the first cladding substrate may be in a range of from 25 microns to 950 microns, 400 to 600 microns, or any sub-ranges contained therein. In an embodiment, the core substrate 210 is formed from a sheet having a thickness tₛ that may be in a range of from 100 microns to 3000 microns, 200 to 400 microns, or any sub-ranges contained therein. Generally, the sheet forming the first cladding substrate is a different thickness than the sheet that forms the core substrate (t_{c1}≠tₛ); in a specific embodiment, the sheet forming the first cladding substrate is thicker than the sheet forming the core substrate (t_{c1}>tₛ). In some three layer embodiments, the sheet that forms the second cladding substrate may be approximately the same thickness as the sheet that forms the first cladding substrate (t_{c1}≈t_{c2}), in which case a symmetrical article is formed. In other three layer embodiments, the sheet that forms the second cladding substrate may be approximately the same thickness as the sheet that forms the core substrate (tₛ≈t_{c2}), in which case an asymmetrical article is formed. In yet other three layer embodiments, the sheet that forms the second cladding substrate may be a different thickness than either the sheet that forms the first cladding substrate (t_{c1}≈t_{c2}) and the sheet that forms the core substrate (tₛ≠t_{c2}), in which case an asymmetrical article is formed.

The core substrate 210 may comprise a first glass composition and the first cladding substrate 220 may comprise a second glass composition, wherein the first glass composition is different from the second glass composition. In an embodiment, the first glass composition has a first ion diffusivity and the second glass composition has a second ion diffusivity, and the first ion diffusivity and second ion diffusivity are different. In an embodiment, the first glass composition has a first coefficient of thermal expansion (CTE) and the second glass composition has a second coefficient of thermal expansion (CTE), and the first CTE and second CTE are different. In an embodiment, the second CTE is lower than the first CTE to impart a compressive stress in the first cladding substrate and the second cladding substrate when both are glasses. In an embodiment, the second CTE is higher than the first CTE to impart a tensile stress in the first cladding substrate and the second cladding substrate when both are glasses. In an embodiment, the second CTE is approximately the same as the first CTE when the cladding substrate is a crystalline material and the core substrate is a glass. In some three layer embodiments, the sheet that forms the second cladding substrate may comprise the second chemical composition of the first cladding substrate, in which case a symmetrical article is formed. In some other three layer embodiments, the sheet that forms the second cladding substrate may comprise a third chemical composition that is different from the first and second chemical compositions, in which case an asymmetrical article is formed. Thus, the sheet that forms the second cladding substrate may have approximately the same CTE as the sheet that forms the first cladding substrate (CTE_{c1}≈CTE_{c2}); or the sheet that forms the second cladding substrate may have a different CTE as the sheet that forms the first cladding substrate (CTE_{c1}≠CTE_{c2}). The sheet that forms the second cladding substrate may have a different CTE from the sheet that forms the core substrate (CTEₛ≠CTE_{c2}).

In an embodiment, one or more additional cladding substrates are bonded to a surface of the first cladding substrate, the second cladding substrate, or both.

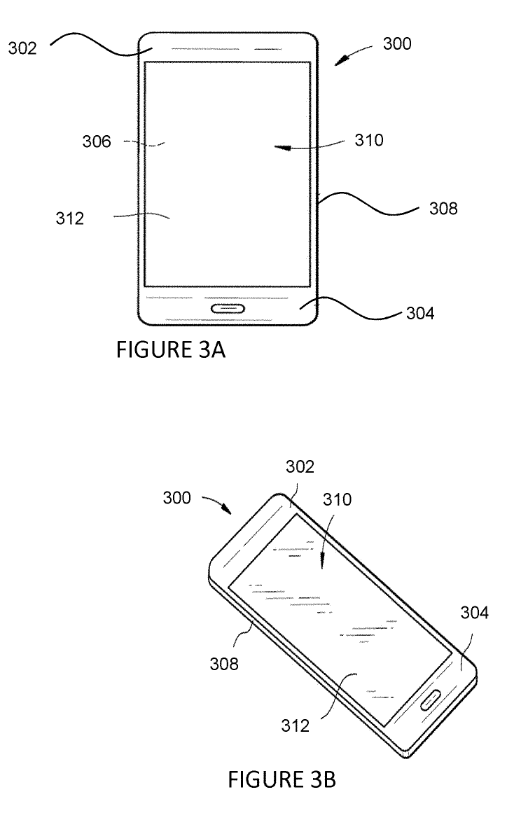

The glass-based articles disclosed herein may be incorporated into another article such as an article with a display (or display articles) (e.g., consumer electronics, including mobile phones, tablets, computers, navigation systems, and the like), architectural articles, transportation articles (e.g., automotive, trains, aircraft, sea craft, etc.), appliance articles, or any article that requires some transparency, scratch-resistance, abrasion resistance or a combination thereof. An exemplary article incorporating any of the strengthened articles disclosed herein is shown in FIGS. 3A and 3B. Specifically, FIGS. 3A and 3B show a consumer electronic device 300 including a housing 302 having front 304, back 306, and side surfaces 308; electrical components (not shown) that are at least partially inside or entirely within the housing and including at least a controller, a memory, and a display 310 at or adjacent to the front surface of the housing; and a cover substrate 312 at or over the front surface of the housing such that it is over the display. In some embodiments, the cover substrate 312 and/or housing 302, or portions thereof, may include any of the glass-based articles disclosed herein.

FIG. 4 is a graphical depiction of modelled stress profiles, which were simulated using finite difference modeling. Stress profiles of a parabolic profile, which simulates the behavior of tempered glass, and an ultra-deep ion exchange profile, where the ions diffuse at least until the center of the sample if not further in the cross-section, are provided as comparative single-layered articles, which are state of the art. Stress profiles of a high DOC laminate (no further processing beyond lamination) and a high DOC laminate further processed with one or more ion exchange steps are provided as exemplary high DOC glass-based articles. The modelled stress profiles of FIG. 4 are illustrated for a glass-based article thickness of 800 microns. With reference to the parabolic profile as a non-limiting example, stress profile 400 comprises a surface compressive stress 415a, 415b at each surface, a compressive region 410a, 410b respectively extending until the DOCs 420a, 420b respectively, from which a center region 430 extends to a maximum tensile stress at 435. For the parabolic profile, the theoretical depth of compression (DOC), 420a, 420b where the stress crosses zero, is approximately 21% of the thickness (about 168 microns). The theoretical DOC for an ultra-deep ion exchange (IOX) where the ions diffuse until the center and beyond across the whole sample thickness is also approximately 21% of the thickness (about 168 microns). After the ions meet in the center of the glass-based article the ultra-deep IOX profile becomes quasi-parabolic leading to approximately similar limitations of a parabolic profile. In the majority of cases, due to the presence of multiple IOX steps and other thermal effects DOC to values are limited to less than about 21% of the thickness, as shown in FIG. 4. High DOC laminates according to the present disclosure are such that the DOC values are greater than or equal to 15%, such as greater than or equal to 18%, and preferentially greater than or equal to 21% of the thickness of the glass-based articles, overcoming the physical limitation of the parabolic and single- or multi-step IOX profiles. For both of the modelled high DOC examples shown in FIG. 4, the DOC is about 37.5% of the thickness (about 300 microns).

DOC values of greater than or equal to 15% of the thickness of the article, such as greater than or equal to 18%, greater than or equal to 21%, greater than or equal to 25%, greater than or equal to 40%, or deeper, are of great interest and not easily achieved by ion exchange alone. High DOC laminates have stress values that may be controlled by the process parameters and material parameters. A shape of the stress profile of the initial laminate alone (e.g., High DOC laminate of FIG. 4) is approximately rectangular in nature. In practice, between the different substrates, a diffusion layer may occur leading to a more gradual transition. Further ion exchange by single- or multiple-steps (such as in the High DOC laminate+IOX) may lead to high DOC and also a particular profile near the surface. For the High DOC laminate+IOX example, a short ion-exchange provides a spike of high stress near the surface of the high DOC laminate while maintaining a pedestal of compressive stress up to about 37.5% of the thickness in the glass-based article before it reaches the tensile region inside the glass-based core substrate.

The cladding and core substrates may be provided using a variety of different processes. For example, exemplary glass-based substrate forming methods include float glass processes and down-draw processes such as fusion draw and slot draw. A glass-based substrate prepared by floating molten glass on a bed of molten metal, typically tin produces a float glass characterized by smooth surfaces and uniform thickness. In an example process, molten glass that is fed onto the surface of the molten tin bed forms a floating glass ribbon. As the glass ribbon flows along the tin bath, the temperature is gradually decreased until the glass ribbon solidifies into a solid glass-based substrate that can be lifted from the tin onto rollers. Once off the bath, the glass-based substrate can be cooled further, annealed to reduce internal stress, and optionally polished.

Down-draw processes produce glass-based substrates having a uniform thickness that possess relatively pristine surfaces. Because the average flexural strength of the glass-based substrate is controlled by the amount and size of surface flaws, a pristine surface has a higher initial strength. When this high strength glass-based substrate is then further strengthened (e.g., chemically), the resultant strength can be higher than that of a glass-based substrate with a surface that has been lapped and polished. Down-drawn glass-based substrates may be drawn to a thickness of less than about 2 mm. In addition, down drawn glass-based substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based substrate. The fusion draw method offers the advantage that, because the two glass films flowing over the channel fuse together, neither of the outside surfaces of the resulting glass-based substrate comes in contact with any part of the apparatus. Thus, the surface properties of the fusion drawn glass-based substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

Examples of glasses that may be used in the core and cladding substrates may include alkali-alumino silicate glass compositions or alkali-containing aluminoborosilicate glass compositions, though other glass compositions are contemplated. Such glass compositions may be characterized as ion exchangeable. In embodiments, glasses used in the core and/or cladding substrates may be substantially free or free of lithium. As used herein, “ion exchangeable” means that a substrate comprising the composition is capable of exchanging cations located at or near the surface of the substrate with cations of the same valence that are either larger or smaller in size.

In a particular embodiment, an alkali-alumino silicate glass composition suitable for the substrates comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σ modifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio ((Al₂O₃+B₂O₃)/Σmodifiers)>1.

In still another embodiment, the substrates may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤(SiO₂+B₂O₃+CaO)≤69 mol. %; (Na₂O+K₂O+B₂O₃+MgO+CaO+SrO)>10 mol. %; 5 mol. %<(MgO+CaO+SrO)≤8 mol. %; (Na₂O+B₂O₃)<Al₂O₃<2 mol. %; 2 mol. %<Na₂O<Al₂O₃<6 mol. %; and 4 mol. %<(Na₂O+K₂O)<Al₂O₃≤10 mol. %.

In another embodiment, the substrates may comprise a lithium-containing alkali aluminosilicate glass. In an embodiment, the lithium-containing alkali aluminosilicate glass has a composition including, in mol. %: SiO₂ in an amount in the range from about 60 mol. % to about 75 mol. %, Al₂O₃ in an amount in the range from about 12 mol. % to about 20 mol. %, B₂O₃ in an amount in the range from 0 mol. % to about 5 mol. %, Li₂O in an amount in the range from about 2 mol. % to about 15 mol. % (such as from about 2 mol. % to about 8 mol. %), Na₂O in an amount greater than about 4 mol. %, MgO in an amount in the range from 0 to about 5 mol. %, ZnO in an amount in the range from 0 to about 3 mol. %, CaO in an amount in the range from 0 to about 5 mol. %, and P₂O₅ in a non-zero amount; wherein the glass substrate is ion-exchangeable and is amorphous, wherein total amount of Al₂O₃ and Na₂O in the composition is greater than about 15 mol. %.

In one or more embodiments, the glass-based articles may have a surface compressive stress after initial lamination in a range of approximately 5-400 MPa.

In one or more embodiments, the glass-based articles herein may have a surface compressive stress after a final IOX step: of 750 MPa or greater, e.g., 800 MPa or greater, 850 MPa or greater, 900 MPa or greater, 950 MPa or greater, 1000 MPa or greater, 1150 MPa or greater, or 1200 MPa or greater, and any values or ranges therebetween.

In one or more embodiments, the glass-based articles herein may have a maximum tensile stress of after lamination and/or after a final IOX step (absolute values): of 2 MPa or greater, 5 MPa or greater, 30 MPa or greater, 35 MPa or greater, 40 MPa or greater, 45 MPa or greater, 50 MPa or greater, or 55 MPa or greater.

In one or more embodiments, the glass-based articles herein may have an absolute value of the stress slope at DOC in the range of from 0.01 MPa/micron to 40 MPa/micron. The stress slope at DOC may be (absolute values): of 10 MPa/microns or less, 5 MPa/microns or less, 2.5 MPa/microns or less, 1 MPa/microns or less, 0.5 MPa/microns or less, 0.3 MPa/microns or less. “Stress slope at DOC” is determined by the slope of a linear fit of a line through DOC ± about 4-5 microns of the stress profile. Due to the lamination, DOC generally falls at the glass based core substrate-cladding substrate interface.

### EXAMPLES

Various embodiments will be further clarified by the following examples. In the Examples, prior to being strengthened, the Examples are referred to as “substrates”. After being subjected to strengthening, the Examples are referred to as “articles” or “glass-based articles”.

Examples 1-4 utilized alkali-alumino silicate glass core substrates in accordance with U.S. Pat. No. 9,156,724, which is incorporated herein by reference. The glass core substrates included: 57.43 mol. % SiO₂, 16.10 mol. % Al₂O₃, 17.05 mol. % Na₂O, 2.81 mol. % MgO, 0.003 mol. % TiO₂, 6.54 mol. % P₂O₅, and 0.07 mol. % SnO₂. The glass core substrates were formed from sheets having a thickness of 320 microns.

Examples 1-4 utilized glass cladding substrates in accordance with U.S. Pat. No. 9,517,967. The glass cladding substrates included: 64.62 mol. % SiO₂, 5.14 mol. % B₂O₃, 13.97 mol. % Al₂O₃, 13.79 mol. % Na₂O, 2.4 mol. % MgO, and 0.08 mol. % SnO₂. The glass cladding substrates were formed from sheets having a thickness of 500 microns.

The laminates of Examples 1-4 possessed a nominal structure of layers 1-2-3, wherein layers 1 and 3 are the cladding substrates and layer 2 is the core substrate. Layers 1 and 3 had the same composition, which was different from the composition of layer 2. Therefore, CTE1=CTE 3. In Examples 1-4, CTE 2 was greater than CTE1 and CTE3, and Thickness 1=Thickness 3, which was >=0.21 of the total thickness of the laminate, which is approximated by (Thickness 1+Thickness 2+Thickness 3). Because CTE 1=CTE 3 and CTE 1<CTE 2 for Examples 1-4, the laminates had a compressive stress in the cladding substrates and a tensile stress in the core substrate. The result was an approximately symmetric laminate in composition, thickness, and stress profile.

### Example 1

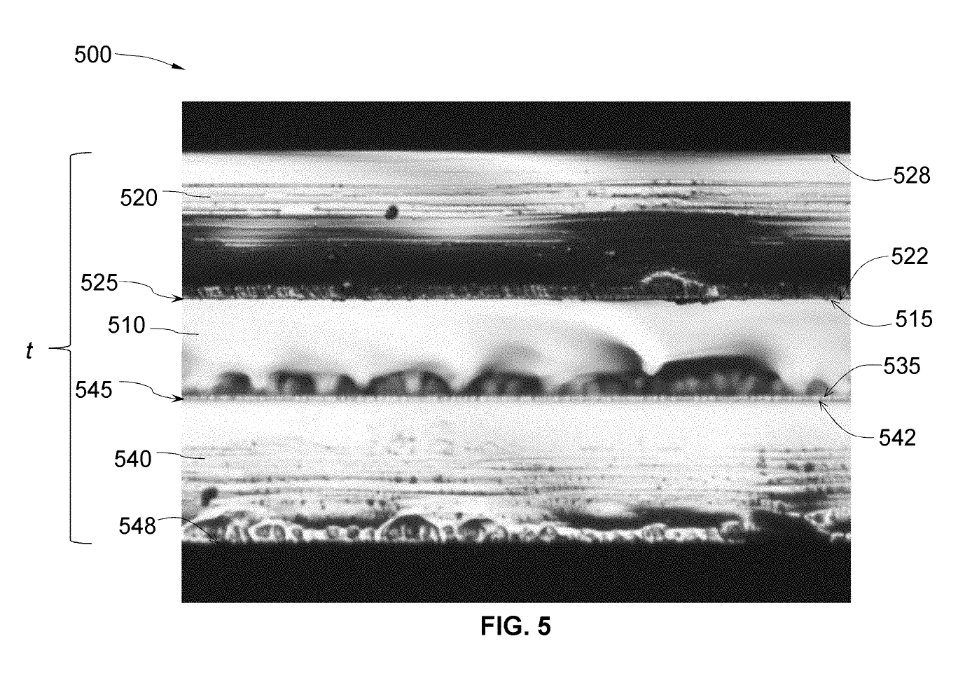

A three-layered 8″×8″ laminate was formed via van der Waals bonding, an optical micrograph for its cross-section is provided in FIG. 5, where the glass-based article 500 had a thickness (t) and three layers: a glass-based core substrate 510, a first cladding substrate 520, and a second cladding substrate 540. The glass-based core substrate 510 had a first surface 515 and a second surface 535. The first cladding substrate 520 had a third surface 522 directly bonded by van der Waals bonding to the first surface 515 to provide a first core-cladding interface 525; the first cladding substrate 520 also had a fourth surface 528. The second cladding substrate 540 had a fifth surface 542 directly bonded to the second surface 535 to provide a second core-cladding interface 545; the second cladding substrate 540 also had a sixth surface 548.

Substrates were cleaned in 2% Semiclean KG solution at 50° C. for 10 minutes in two successive tanks with 70 and 110 kHz ultrasonic agitation, followed by rinsing in two static DI water tanks at 50° C. The substrates were then air-dried, and manually assembled by stacking and alignment. The assembled substrates were then heated in an oven, where bonding occurred rapidly. Bonded laminates were fused by annealing at 450° C. for 2 hours in a vacuum oven. The 8″×8″ laminate was mechanically cut with a standard diamond glass cutting tool to dice the large laminate into multiple 2 inch×2 inch squares. Additional sample shapes and sizes can be cut directly after the first van der Waals bonding step.

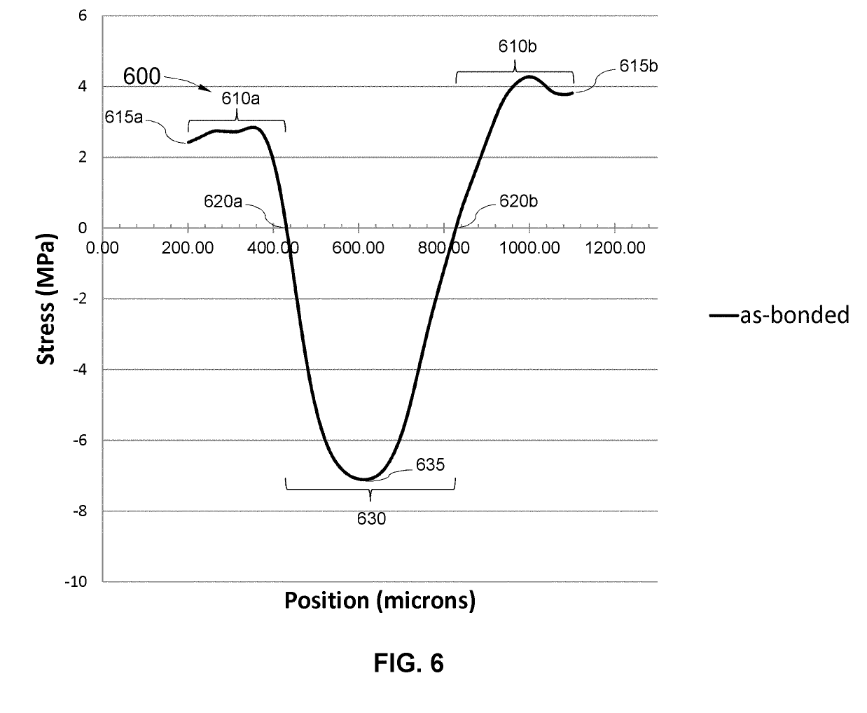

FIG. 6 provides a graph of a stress profile measurement by a SCALP-5 measurement system as a function of positions from 200 microns to 1100 microns for Example 1, which was induced by the initial formation/bonding via the van der Waals attachment technique. The stress profile of FIG. 6 is approximately symmetrical. The measurement shown in FIG. 6 is an average of 16 measurements with an exposure time of 10 seconds for each measurement. FIG. 6 shows stress profile 600 having a compressive regions 610a and 610b that extend to DOCs 620a and 620b. FIG. 6 shows that a compressive stress 615a, 615b is induced in at each surface and a tensile stress is induced in the center region 630. At approximately 0.5·t (nominally 660 microns) the stress (or maximum tensile stress) 635 was −7.1 MPa (or 7.1 MPa in absolute terms). The stress profile is approximately rectangular in accordance with the model shown in FIG. 4. In the DOC region where the profile crosses 0 MPa stress, the transition is not as abrupt as in the model of FIG. 4, but more gradual. This is likely due to relaxation of the stress at the interface and also to possible ion diffusion between the cladding and core substrates. DOC from a first surface at “0” microns, was located at about 430 microns, which is about 0.325 or about 32.5% of total thickness (nominally 1,320 microns). DOC from a second surface at “1320” microns, was located at about 490 microns from the second surface (corresponding to about 830 microns on the x-axis of FIG. 6), which is about 0.371 or about 37.1% of total thickness (nominally 1,320 microns). These DOC values are significantly larger than the generally accepted limit of a DOC of about 21% of thickness achieved by ion-exchange alone. Such a value of DOC normalized per thickness is not generally achieved either by ion-exchange or annealing/tempering techniques on single-layered articles.

### Example 2

A series of laminates was formed via van der Waals bonding followed by annealing. The van der Waals bonding was conducted according to Example 1. After lamination, an oven was used to anneal the various laminates, at a temperature ranging from 600° C.-700° C. for a duration of 10 minutes to 30 minutes.

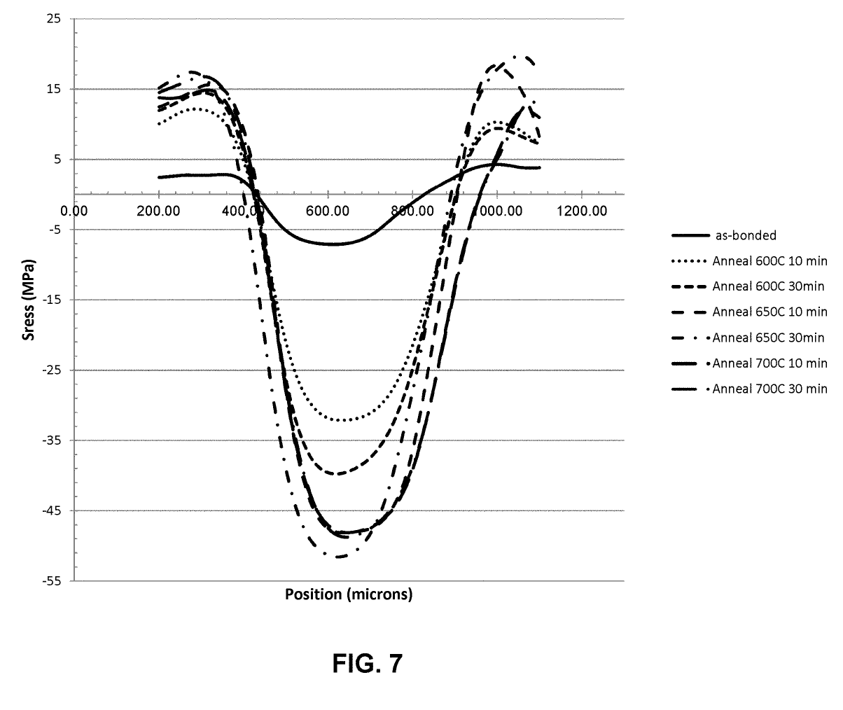

FIG. 7 provides a graph of a stress profile measurements for the various laminates by a SCALP-5 measurement system as a function of positions from 200 microns to 1100 microns for Example 2, which was induced by the initial formation/bonding done via van der Waals attachment technique followed by annealing. The lamination led to an initial stress profile and the annealing allowed for tuning of the initial stress profile. The stress profiles of FIG. 7 are approximately symmetrical. The profile for the as-bonded only (no annealing) of Example 1 is also included in FIG. 7 for reference. Without regard to edge regions, FIG. 7 and Table 1 show that a compressive stress is induced in the surface and a maximum tensile stress is induced in the center region, which is between the DOCs. Between the surface compressive stress and the DOC is a compressive region. The stress profile is approximately rectangular in accordance with the model shown in FIG. 4. In the DOC region where the profile crosses 0 MPa stress, the transition is not as abrupt as in the model of FIG. 4 but more gradual. This is likely due to relaxation of the stress at the interface and also to possible ion diffusion between the cladding and core substrates. DOC of the annealed samples from a first surface at “0” microns, was located in a range of from about 410 to about 430 microns, which is about 0.311 to about 0.325 or about 31.1 to about 32.5% of total thickness (nominally 1,320 microns). DOC of the annealed samples from a second surface at “1320” microns, was located in a range of from about 360 to about 430 microns from the second surface (corresponding to about 890 to about 960 microns on the x-axis of FIG. 7), which is about 0.272 to about 0.325 or about 27.2 to about 32.5% of total thickness (nominally 1,320 microns). These DOC values are significantly larger than the generally accepted limit of a DOC of about 21% of thickness limit that is achieved by ion-exchange alone. With reference to FIG. 7, a secondary annealing temperature of 650° C. for 30 minutes provided the largest increase in center tension inside the glass, from −7 MPa (or 7 MPa in absolute terms) for the non-annealed as-bonded to about −50 MPa (or 50 MPa in absolute terms) after annealing. Parameters of the stress profiles of the annealed samples, including surface stress (CS) of both surfaces, DOC from both surfaces, and maximum tensile stress, are provided in Table 1. “Stress slope at DOC” is determined by a linear fit of a line through DOC ± about 4-5 microns of the measured stress profile and the absolute value of the stress slope at DOC is reported in Table 1.

TABLE 1

| | | | | Absolute |
|---|---|---|---|---|
| | | | | Value of |
| | | | | Stress |
| | | | | Slope at |
| Anneal | | Position | Stress | DOC |
| Conditions | Parameter | (μm) | (MPa) | (MPa/μm) |
| 600° C. | Surface | 200 | 10 | — |
| 10 min | Stress | | | |
| | DOCa | 424 | 0.1 | 0.24 |
| | Maximum | 640 | −32.1 | — |
| | Tensile | | | |
| | Stress | | | |
| | DOCb | 903 | 0.1 | 0.22 |
| | Surface | 1100 | 7.4 | — |
| | Stress | | | |
| 600° C. | Surface | 200 | 11.9 | — |
| 30 min | Stress | | | |
| | DOCa | 424 | 0.1 | 0.29 |
| | Maximum | 618 | −39.8 | — |
| | Tensile | | | |
| | Stress | | | |
| | DOCb | 903 | 0.1 | 0.21 |
| | Surface | 1100 | 7.2 | — |
| | Stress | | | |
| 650° C. | Surface | 200 | 12.5 | — |
| 10 min | Stress | | | |
| | DOCa | 436 | 0.4 | 0.34 |
| | Maximum | 640 | −48.1 | — |
| | Tensile | | | |
| | Stress | | | |
| | DOCb | 906 | 0.1 | |
| | Surface | 1100 | 8.3 | — |
| | Stress | | | |
| 650° C. | Surface | 200 | 15.1 | — |
| 30 min | Stress | | | |
| | DOCa | 402 | −0.6 | 0.35 |
| | Maximum | 623 | −51.6 | — |
| | Tensile | | | |
| | Stress | | | |
| | DOCb | 890 | 0.1 | 0.29 |
| | Surface | 1100 | 17 | — |
| | Stress | | | |
| 700° C. | Surface | 200 | 13.8 | — |
| 10 min | Stress | | | |
| | DOCa | 427 | 0 | 0.3 |
| | Maximum | 646 | −48.1 | — |
| | Tensile | | | |
| | Stress | | | |
| | DOCb | 958 | −0.1 | 0.16 |
| | Surface | 1100 | 10.9 | — |
| | Stress | | | |
| 700° C. | Surface | 200 | 14.5 | — |
| 30 min | Stress | | | |
| | DOCa | 430 | 0.2 | 0.32 |
| | Maximum | 644 | −48.8 | — |
| | Tensile | | | |
| | Stress | | | |
| | DOCb | 960 | −0.1 | 0.16 |
| | Surface | 1100 | 12.8 | — |
| | Stress | | | |

### Example 3

A laminate was formed via van der Waals bonding followed by annealing and single-step ion exchange. The van der Waals bonding was conducted according to Example 1. The annealing was conducted in accordance with Example 2 at 650° C. for 30 minutes. After annealing, a single-step ion-exchange was performed by immersing the sample in a bath containing KNO₃ for 12 minutes at a temperature of 390° C.

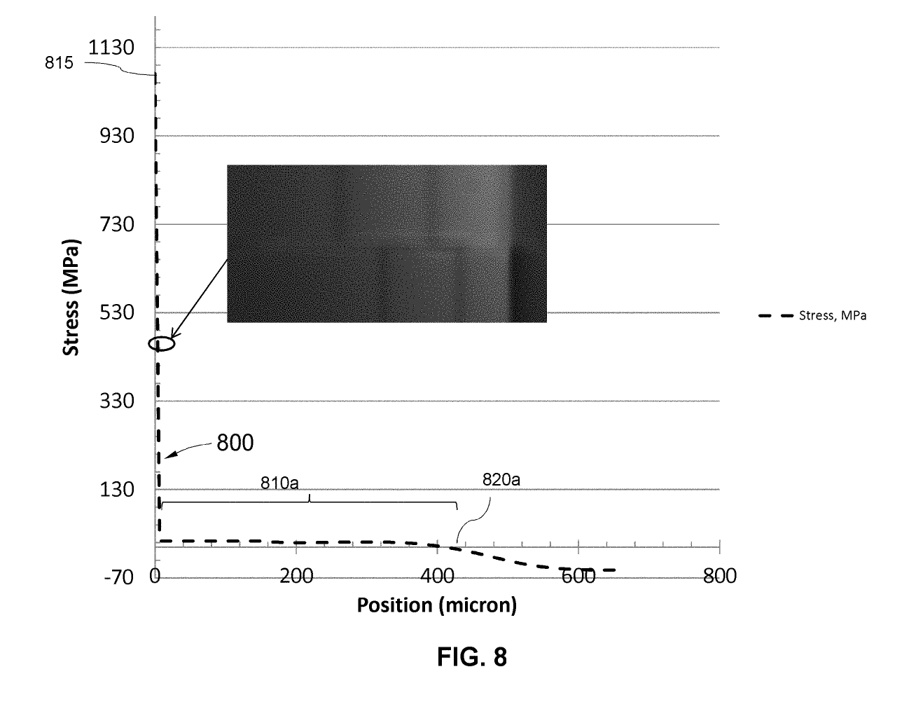

FIG. 8 provides a graph of a stress profile measurement of a half width (up to 0.5·t) as a function of position from 0 microns to 660 microns for Example 3, which was induced by the initial formation/bonding done via van der Waals attachment technique followed by annealing, followed by single-step ion exchange (IOX). FIG. 8 shows stress profile 800 having a compressive region 810a that extends to DOC 820a. As shown in FIG. 8, the ion exchange induces a large stress in the near surface 815, which was observed/measured by the presence of fringes in an FSM-6000 stress measurement system from Orihara, Co. Japan. The measurements indicate the presence of a surface stress 815 of 1,070 MPa with a diffusion depth of about 6.5 microns with the IOX induced stress being superimposed on the stress induced by the lamination of the laminate. It is understood that a comparable surface stress would be found at the opposite surface. The deeper part of the stress in the laminate between 200 microns and 660 microns was measured by scattering polarimetry using a SCALP-5 measurement. The stress profile of FIG. 8 is approximately symmetrical. The stress profile towards the center approximately rectangular in accordance with the model shown in FIG. 4. In the DOC region where the profile crosses 0 MPa stress, the transition is not as abrupt as in the model of FIG. 4 but more gradual. This is likely due to relaxation of the stress at the interface and also to possible ion diffusion between the cladding and core substrates. DOC from a first surface at “0” microns 820a was located at about 430 microns, which is about 0.325 or 32.5% of total thickness (nominally 1,320 microns). This DOC value is significantly larger than the generally accepted limit of a DOC of about 21% of thickness limit achieved by ion-exchange alone. The IOX step complements the stress profile by providing a region of high stress near the surface, while at the same time maintaining an approximate 10 MPa compressive stress in the compressive regions 810a between the surface and the DOC. The center tension (CT) in the middle of the device at position about 660 microns, was approximately −52 MPa (or 52 MPa in absolute terms).

### Example 4

A laminate was formed via fusion, which was conducted at a temperature in the range of from 700° C. to 1,000° C., including a ramp up from ambient temperature to the target temperature over about 12 hours, a hold time of about 12 hours, and a cooling time to ambient of about 24 hours.

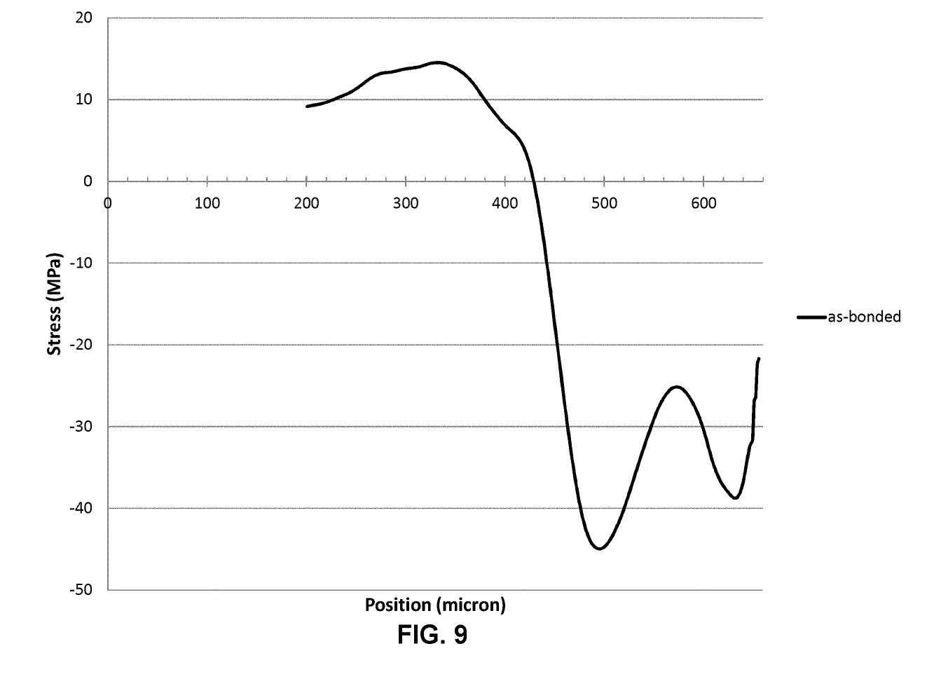

FIG. 9 provides a graph of a stress profile measurement of a half width (up to 0.5·t) according to by a SCALP-5 measurement system as a function of positions from 200 to 660 microns for Example 4, which was induced by the initial formation/bonding done via fusion. The first half width is the measurement to the approximate center of the article, which in this case is nominally 660 microns. The stress profile of FIG. 9 is expected to be approximately symmetrical. Without regard to the edge region, FIG. 9 shows that a compressive stress is induced in the surface and a tensile stress is induced in the center region. The stress profile is expected to be approximately rectangular in accordance with the model shown in FIG. 4. In the DOC region where the profile crosses 0 MPa stress, the transition is not as abrupt as in the model of FIG. 4 but more gradual. This is likely due to relaxation of the stress at the interface and also to possible ion diffusion between the glasses. DOC from a first surface at “0” microns was located at about 430 microns, which is about 0.325 or about 32.5% of total thickness (nominally 1,320 microns). This DOC value is significantly larger than the generally accepted limit of a DOC about 21% of thickness achieved by ion-exchange alone. In comparison to the stress induced initially by the first van der Waals bonding in accordance with Example 1, the stress magnitudes of the fusion bonding are significantly higher. This is likely because the fusion bonding happens at a very high temperature (>700° C.). For the fusion example, additional annealing will likely not further increase the stress further, but will enable the tuning of the stress if needed. The current sample made by fusion could also be ion exchanged if desired.

### Example 5

Example 5 utilized glass core substrates in accordance with U.S. Pat. No. 8,951,927, which is incorporated herein by reference. The glass core substrates included: 67.37 mol. % SiO₂, 3.67 mol. % B₂O₃, 12.73 mol. % Al₂O₃, 13.77 mol. % Na₂O, 0.01 mol. % K₂O, 2.39 mol. % MgO, 0.01 mol. % Fe₂O₃, 0.01 mol. % ZrO₂, and 0.09 mol. % SnO₂. The glass core substrate was formed from a sheet having a thickness of 330 microns.

Example 5 utilized mechanically polished basal plane sapphire cladding substrates. The sapphire was single crystal. The sapphire cladding substrates were formed from sheets having a thickness of 450 microns.

Laminates of Example 5 possessed a nominal structure of layers 1-2-3, wherein layers 1 and 3 are the cladding substrates and layer 2 is the core substrate. Layers 1 and 3 had the same composition, which was different from the composition of layer 2. Therefore, CTE1=CTE 3. Thickness 1=Thickness 3, which was greater than or equal to 21% of the total thickness of the laminate, which is approximated by (Thickness 1+Thickness 2+Thickness 3). In Example 5, CTE2 was approximately the same as CTE1 and CTE3. For bonding among crystalline and glass materials, without intending to be bound by theory, it is believed that the CTEs of the two types of materials should be about the same or have a difference of less than 10×10⁻⁷1° C. Upon lamination, an induced stress is still formed in the laminate. The result was an approximately symmetric laminate in composition, thickness, and stress profile.

A series of laminates were formed at varying bonding temperatures (400° C., 450° C., 500° C., and 550° C.) via van der Waals bonding. SC1 treatment (cleaning with a 40:1:2 solution of H₂O:NH₄OH:H₂O₂) was applied to the sapphire cladding sheets.

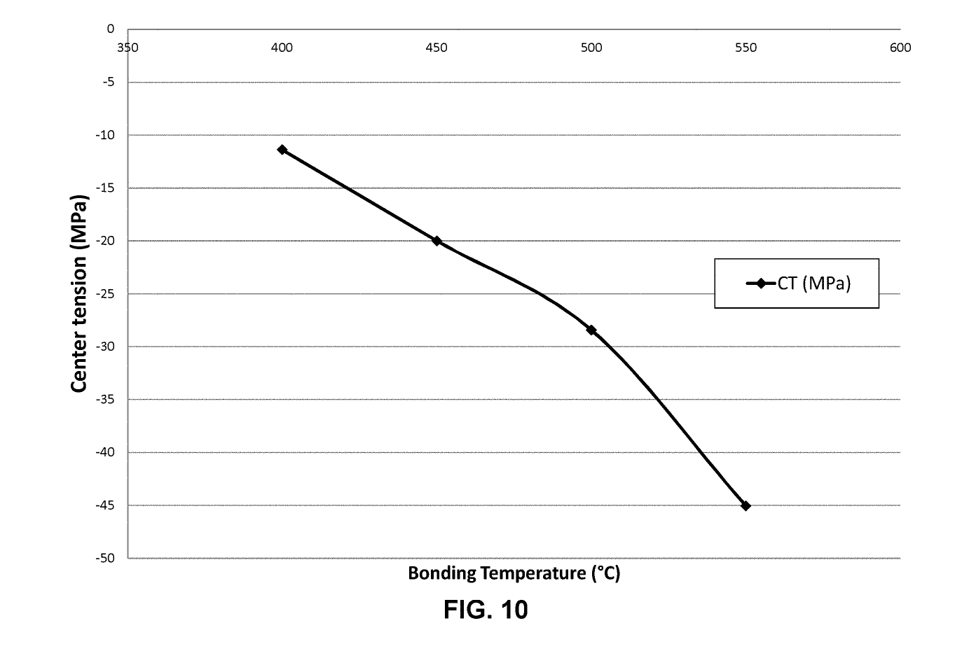

FIG. 10 provides a graph of center tension by a SCALP-5 measurement system versus temperature according to Example 5, which was induced by the initial formation/bonding done via van der Waals attachment technique. The SCALP-5 measurement system is not capable of determining the entire stress profile due to the refractive index of the sapphire materials. However, in the interior of the laminate, the SCALP-5 measurement system is able to quantify the stress in the laminate. The measurement shown is an average of 16 measurements with exposure time of 10 seconds for each measurement. FIG. 10 shows that the tensile stress induced in the center region varying with bonding temperature.

### Example 6

Example 6 was formed with a fusion draw process, where the glass core substrates and the glass cladding substrates were formed simultaneously to produce the laminated article. The article included two cladding layers directly bonded through the fusion process to the core layer. The glass core layer included: 58.54 mol. % SiO₂, 15.30 mol. % Al₂O₃, 16.51 mol. % Na₂O, 2.28 mol. % K₂O, 1.07 mol. % MgO, 6.54 mol. % P₂O₅, and 0.10 mol. % SnO₂. The glass cladding layers included: 64.62 mol. % SiO₂, 5.14 mol. % B₂O₃, 13.97 mol. % Al₂O₃, 13.79 mol. % Na₂O, 2.40 mol. % MgO, and 0.08 mol. % SnO₂.

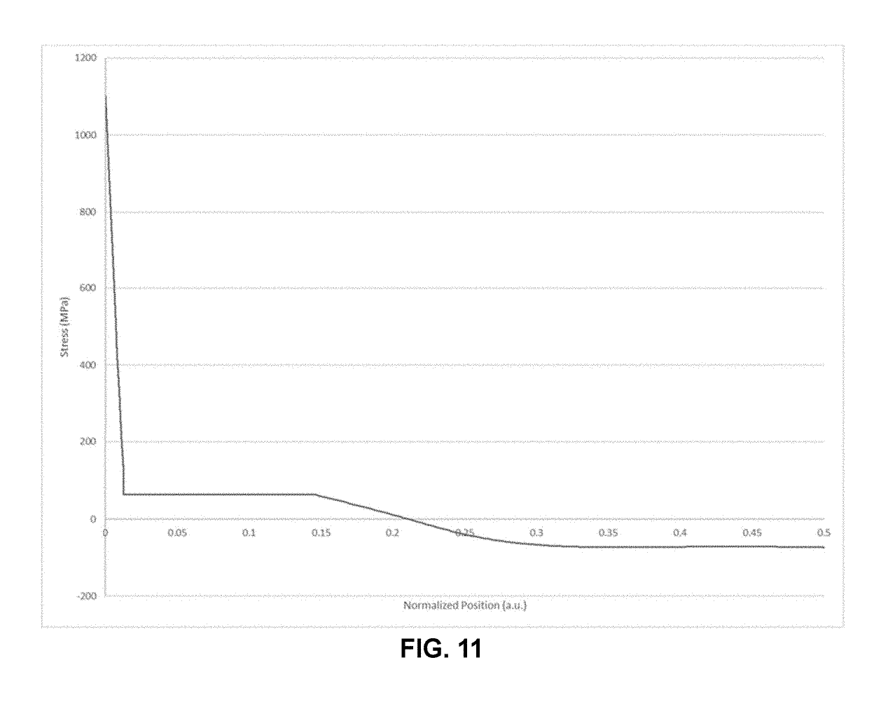

After formation, the article was ion exchanged in a bath including 100 wt. % KNO₃ at a temperature of 410° C. for 30 minutes to form a compressive stress spike at the surface. The stress profile of the ion exchanged article was measured with the SCALP method at depths greater than 100 μm from the surface and the stress in the near surface region was measured with an IWKB method, with the results being combined to produce the stress profile as shown in FIG. 11. The depth of compression was measured at about 21% of the thickness for a sample having a thickness of 750 μm, and a depth of the spike was about 10 μm. The spike had a peak compressive stress of about 1.1 GPa. As shown in FIG. 11, the stress profile includes a pedestal region after the spike with a near constant compressive stress of about 63 MPa, as measured by FSM. The ion exchanged article exhibited a maximum central tension of about 73 MPa.

### Example 7

Example 7 was formed with a fusion draw process, where the glass core substrates and the glass cladding substrates were formed simultaneously to produce the laminated article. The article included two cladding layers directly bonded through the fusion process to the core layer. The glass core layer included: 58.54 mol. % SiO₂, 15.30 mol. % Al₂O₃, 16.51 mol. % Na₂O, 2.28 mol. % K₂O, 1.07 mol. % MgO, 6.54 mol. % P₂O₅, and 0.10 mol. % SnO₂. The glass cladding layers included: 64.62 mol. % SiO₂, 5.14 mol. % B₂O₃, 13.97 mol. % Al₂O₃, 13.79 mol. % Na₂O, 2.40 mol. % MgO, and 0.08 mol. % SnO₂.

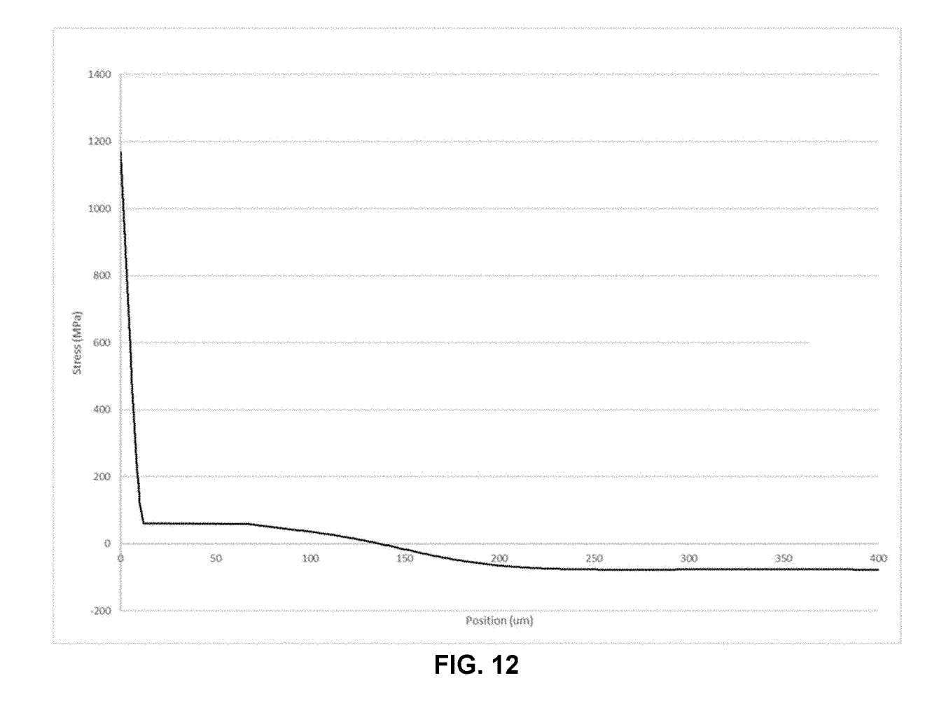

After formation, the article was ion exchanged in a bath including 100 wt. % KNO₃ at a temperature of 410° C. for 30 minutes to form a compressive stress spike at the surface. The stress profile of the ion exchanged article was measured with the SCALP method at depths greater than 100 μm from the surface and the stress in the near surface region was measured with an IWKB method, with the results being combined to produce the stress profile as shown in FIG. 12. The thickness of each of the cladding layers was measured at about 25% of the thickness for samples having a thickness of 0.7 mm to 0.9 mm, and a depth of the spike was about 10 μm. The spike had a peak compressive stress of about 1150 MPa. As shown in FIG. 12, the stress profile includes a pedestal region after the spike with a near constant compressive stress of about 63 MPa, as measured by FSM. The ion exchanged article exhibited a maximum central tension of about 77 MPa.

Articles where each of the cladding layers had a thickness of about 45% of the thickness were also produced, but the stress profile was not measured.

While the foregoing is directed to various embodiments, other and further embodiments of the disclosure may be devised without departing from the basic scope thereof, and the scope thereof is determined by the claims that follow.

What is claimed is:

1. An article comprising:
a thickness (t);
a glass-based core substrate;
a cladding substrate directly bonded to the glass-based core substrate; and
a stress profile comprising a depth of compression (DOC) that is located at 0.15·t or deeper.

2. The article of claim 1, wherein the glass-based core substrate has opposing first and second surfaces and the cladding substrate has opposing third and fourth surfaces, the third surface being directly bonded to the first surface to provide a core-cladding interface, and a compressive stress region of the stress profile begins at the fourth surface and extends to the DOC.

3. The article of claim 1, wherein the cladding substrate is formed from a sheet having a thickness of t_{c1}, which is at least 0.15·t.

4. The article of claim 1, wherein the glass-based core substrate has a core coefficient of thermal expansion (CTEₛ) and the cladding substrate has a cladding coefficient of thermal expansion (CTE_{c}), wherein the CTEₛ is different from the CTE_{c}.

5. The article of claim 1, wherein the DOC is located at 0.25·t or deeper.

6. The article of claim 1, wherein the DOC is in the range of approximately 0.21·t to 0.49·t.

7. The article of claim 1, wherein the t is in a range of 0.1 mm to 10 mm.

8. The article of claim 1, wherein the cladding substrate is bonded to the core substrate by fusion bonding, covalent bonding, or hydroxide-catalyzed bonding.

9. The article of claim 1, wherein the stress profile comprises an absolute value of stress slope at the DOC in the range of from 0.01 MPa/micron to 40 MPa/micron.

10. The article of claim 1, wherein the stress profile comprises an absolute value of maximum tensile stress of 2 MPa or more.

11. The article of claim 1, further comprising one or more additional cladding substrates bonded to a surface of the glass-based core substrate, the cladding substrate, or both.

12. The article of claim 1, wherein the glass-based core substrate comprises a glass or a glass-ceramic.

13. The article of claim 1, wherein the cladding substrate is a crystalline material or a glass-ceramic.

14. The article of claim 1, wherein the cladding substrate comprises a crystalline material selected from the group consisting of: aluminum oxy-nitride (ALON), spinel, sapphire, zirconia, and combinations thereof.

15. The article of claim 1, wherein at least one of the cladding substrate and the glass-based core substrate is substantially free of lithium.

16. A consumer electronic product comprising:
a housing having a front surface, a back surface, and side surfaces;
electrical components provided at least partially within the housing, the electrical components including at least a controller, a memory, and a display, the display being provided at or adjacent the front surface of the housing; and
a cover substrate disposed over the display,
wherein at least a portion of at least one of the cover substrate and the housing comprises the article claim 1.

17. An article comprising:
a thickness (t);
a glass-based core substrate having a core coefficient of thermal expansion (CTEₛ) and opposing first and second surfaces;
a first cladding substrate having a first cladding coefficient of thermal expansion (CTE_{c1}) and opposing third and fourth surfaces, the third surface being directly bonded to the first surface to provide a first core-cladding interface; and
a second cladding substrate having a second cladding coefficient of thermal expansion (CTE_{c2}) and opposing fifth and sixth surfaces, the fifth surface being directly bonded to the second surface to provide a second core-cladding interface; and
wherein the first cladding substrate is formed from a sheet having a thickness of t_{c1} and the second cladding substrate is formed from a sheet having a thickness of t_{c2}, and at least one of t_{c1} and t_{c2} is at least 0.15·t.

18. The article of claim 17, wherein CTEₛ is greater or equal to than each of CTE_{c1} and CTE_{c2}.

19. The article of claim 17, wherein CTE_{c1} and CTE_{c2} are each greater than CTEₛ.

20. The article of claim 17, comprising a stress profile having a compressive stress region extending from the fourth surface to a depth of compression (DOC), the DOC being located at 0.15·t or deeper, and a tensile stress region extending from the DOC to a maximum tensile stress.

21. The article of claim 20, wherein the DOC is located at 0.25·t or deeper.

22. The article of claim 20, wherein the DOC is in the range of approximately 0.21·t to 0.49·t.

23. The article of claim 17, wherein the glass-based article has a thickness in a range of 0.1 mm to 10 mm.

24. The article of claim 17, wherein the first cladding substrate and the second cladding substrate are each bonded to the glass-based core substrate by fusion bonding, covalent bonding, or hydroxide-catalyzed bonding.

25. The article of claim 20, wherein the stress profile comprises an absolute value of stress slope at the DOC in the range of from 0.01 MPa/micron to 40 MPa/micron.

26. The article of claim 20, wherein the stress profile comprises an absolute value of maximum tensile stress of 2 MPa or more.

27. The article of claim 17, wherein at least one of the first cladding substrate, the second cladding substrate, and the glass-based core substrate is substantially free of lithium.

28. A consumer electronic product comprising:
a housing having a front surface, a back surface, and side surfaces;
electrical components provided at least partially within the housing, the electrical components including at least a controller, a memory, and a display, the display being provided at or adjacent the front surface of the housing; and
a cover substrate disposed over the display,
wherein at least a portion of at least one of the cover substrate and the housing comprises the article of claim 17.

29. A method of manufacturing an article having a thickness (t) comprising:
directly bonding a first cladding substrate that is glass, crystalline, or glass-ceramic to a first side of a glass-based core substrate;
wherein the first cladding material has a thickness of t_{c1}, and t_{c1} is at least 0.15·t, the article has a stress profile having a compressive stress (CS) at or below a surface of the article and a compressive region extending to a depth of compression (DOC), the DOC being located at 0.15·t or deeper, and a tensile stress region extending from the DOC to a maximum tensile stress

30. The method of claim 29, further comprising cleaning the glass-based core substrate and the first cladding substrate; and placing a bonding surface of the glass-based core substrate in contact with a bonding surface of the first cladding substrate to provide a laminate stack.

31. The method of claim 30, further comprising heating and/or treating the laminate stack to bond the bonding surfaces.

32. The method of claim 31, further comprising annealing the laminate stack at a temperature in a range from about 100° C. to about 1000° C. for a period of time of at least 30 minutes and up to 24 hours.

33. The method of claim 29, further comprising chemically strengthening the first cladding substrate by ion exchange.
